(19) United States
(12) Patent Application Publication
(10) Pub. No.: US 2026/0017463 A1
(43) Pub. Date: Jan. 15, 2026

(54) SYSTEM FOR FACILITATING COMMUNICATION BETWEEN AI AGENTS

(71) Applicant: City University of Hong Kong, Hong Kong (HK)

(72) Inventors: Dapeng WU, Hong Kong (HK); Shiqi WANG, Hong Kong (HK); Peilin CHEN, Hong Kong (HK)

(21) Appl. No.: 19/269,078

(22) Filed: Jul. 15, 2025

Related U.S. Application Data
(60) Provisional application No. 63/671,282, filed on Jul. 15, 2024.

(51) Int. Cl. G06F 40/35; G06F 40/242; G06F 40/40; G06V 10/70; G06V 20/40; G06V 20/56

(52) U.S. Cl. CPC G06F 40/35; G06F 40/242; G06F 40/40; G06V 10/70; G06V 20/44; G06V 20/47; G06V 20/56

(57) ABSTRACT

The present invention provides a system for facilitating communication between AI agents by processing and interpreting real-time scene data in response to mission-related requests. The system includes sensory devices within an AI agent to collect environmental data and a large language model module to construct a mission-specific event dictionary. A perception engine processes the collected data, while a cognition engine extracts semantic information. A decision engine identifies mission-relevant events using the event dictionary. An integrated operating platform, comprising processors and memory, supports a multi-tiered communication framework: at the perception tier, encoded data is transmitted; at the cognition tier, selected scene descriptions are shared; and at the decision tier, mission-relevant event descriptors are communicated. This architecture ensures context-aware, tier-specific information exchange tailored to the recipient AI agent's mission needs.

### CROSS-REFERENCE TO RELATED APPLICATIONS

The present application claims priority from the U.S. Provisional Patent Application No. 63/671,282 filed 15 Jul. 2024, and the disclosure of which is incorporated herein by reference in its entirety.

### FIELD OF THE INVENTION

The present invention generally relates to artificial intelligence (AI) technologies, and specifically related to an efficient framework for facilitating communication between AI agents.

### BACKGROUND OF THE INVENTION

The next-generation industry such as Industry 4.0 heavily relies on communication between AI agents at perception, cognition, and decision levels, respectively. If an AI agent (or recipient) wants to see what is happening at a far-away location, due to “seeing is believing”, it can choose the perception tier, in which non-text sensory signals such as videos are transmitted for perception by the recipient itself directly rather than by others. If the recipient wants to save time and bandwidth, it can choose the cognition tier, in which text messages are generated to summarize the video captured in the perception tier; herein, the video is perceived by others rather than by the recipient of the cognition tier. If the recipient wants text messages that are relevant to its assigned mission (e.g., driving safely), it can choose the decision tier, in which mission-relevant text messages are generated to summarize the captured video captured.

In current communication infrastructures, non-text signal communication at perception tier and semantic communication at cognition tier are usually independently studied without synergistic efforts. Few attempts have been made to goal-oriented communication at the decision tier. The state-of-the-art signal quality measures cannot be employed to quantify the pragmatic value of information for a particular mission. Therefore, assembling the existing solutions for communication between AI agents over the three tiers is unsuitable.

Prior works on the perception tier boil down to the optimization of the signal representation based upon the signal fidelity subjected to the bit-rate constraints (e.g., video coding). However, the characteristics of the ultimate receiver for perception by an AI agent or a human, have not been well considered. For the cognition tier, existing strategies are to transmit all scene descriptions without considering their relevance with respect to the recipient, leading to waste of bandwidth due to transmission of irrelevant messages. For the decision tier, existing task-oriented semantic communication technologies focus on signal/information processing tasks (e.g., image segmentation), which themselves are not high-level tasks in daily activities of human society.

### SUMMARY OF THE INVENTION

An objective of the present invention is to provide a communication system and associated network infrastructure configured to facilitate structured, context-aware communication among autonomous agents operating at perception, cognition, and decision-making tiers. The communication system may be deployed in various technical fields, including but not limited to, autonomous vehicle control systems and intelligent security monitoring platforms.

In accordance with one aspect of the present invention, the communication system comprises: one or more sensory devices for collecting data from a scene associated to a request from a peer AI agent in real-time; a large language model module for constructing a mission-specific event dictionary when the request is associated with a mission assigned to the peer AI agent; a perception engine configured to process the collected data; a cognition engine configured to extract semantic information from the processed data; a decision engine configured to detect one or more mission-relevant events from the extracted semantic information based on the mission-specific event dictionary; an operating platform including a communication module, one or more processors and a memory in communication with the one or more processors and storing instructions that, when executed by the one or more processors, cause the communication system to operate: at a perception tier such that the perception engine is further configured to encode the processed data and the communication module is configured to transmit the encoded data to the AI recipient agent; at a cognition tier such that the cognition engine is further configured to select one or more scene descriptions from the extract semantic information and the communication module is configured to transmit the one or more selected scene descriptions to the AI recipient agent; or at a decision tier such that the decision engine is further configured to generate mission-relevant event descriptors based on the one or more detected mission-relevant events and the communication module is configured to transmit the generated mission-relevant response to the AI recipient agent.

Preferably, the perception engine comprises: a data processing module configured to process the collected data; and a data coding module configured for encoding the processed data.

Preferably, the data coding module is further configured for encoding the processed data subject to a rate-distortion-power-delay optimization algorithm in which bite rate, visual distortion, power consumption and end-to-end delay are balance based on a specific perceptual rate-distortion relationship.

Preferably, the cognition engine comprises: one or more natural language processors configured to extract semantic information from the processed data; and a scene description selection module configured to select the one or more scene descriptions from the extracted semantic information.

Preferably, the scene description selection module is further configured to select the one or more scene descriptions from the extracted semantic information through a rate-accuracy optimization algorithm based on accuracy in reflecting common-sense under a bit-rate budget.

Preferably, the scene description selection module is further configured to select the one or more scene descriptions from the extracted semantic information through a rate-accuracy optimization algorithm based on accuracy in reflecting mission-relevant information under a bit-rate budget.

Preferably, the decision engine comprises: an event detection module configured to: detect one or more mission-relevant events from the extracted semantic information based on the mission-specific event dictionary; an event analysis module configured to: construct a scene graph, wherein the scene graph including one or more triplets representing the one or more detected events occurring in the scene; assign a pragmatic value to each triplet in scene graph; and select one or more triplets of highest pragmatic values; and a deep-learning-based transformer configured to convert the one or more selected triplets into the one or more mission-relevant event descriptors.

Preferably, the one or more triplets of highest pragmatic values are selected through a rate-value optimization algorithm under a specified bit-rate budget.

Preferably, the mission-relevant events are detected through multi-modality sensory interpretation.

Preferably, the pragmatic value is computed through a trained deep-learning model; and the trained deep-learning model is configured to access contribution of each triplet to mission objectives based on historical data and contextual mission requirements.

The disclosed invention introduces a mission-oriented communication scheme that enables the transmission and interpretation of data in accordance with the specific functional roles and operational objectives assigned to AI agent. The provided communication system can extract and prioritize mission-relevant information, thereby enabling goal-directed interaction among distributed AI agents. Furthermore, the invention provides a universal yet modular functional programming framework configured to operate across the perception, cognition, and decision-making tiers. The framework supports adaptive expansion and can add or remove modules (such as third-party algorithm libraries, edge inference nodes, etc.) according to actual application needs, facilitating flexible deployment in various scenarios. The framework also enables the instantiation of tier-specific communication logic while maintaining compatibility through a standardized interface. This approach yields significant improvements in communication efficiency, scalability, and responsiveness, particularly in distributed, autonomous operational environments.

### BRIEF DESCRIPTION OF DRAWINGS

Embodiments of the invention are described in more details hereinafter with reference to the drawings, in which:

FIG. 1A shows a communication system in accordance with one embodiment of the present invention; and FIG. 1B shows a communication system in accordance with another embodiment of the present invention.

FIG. 2 illustrates an exemplary implementation of the communication system for a scenario in autonomous driving.

FIG. 3 illustrates a workflow in the communication system operated at the decision tier.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

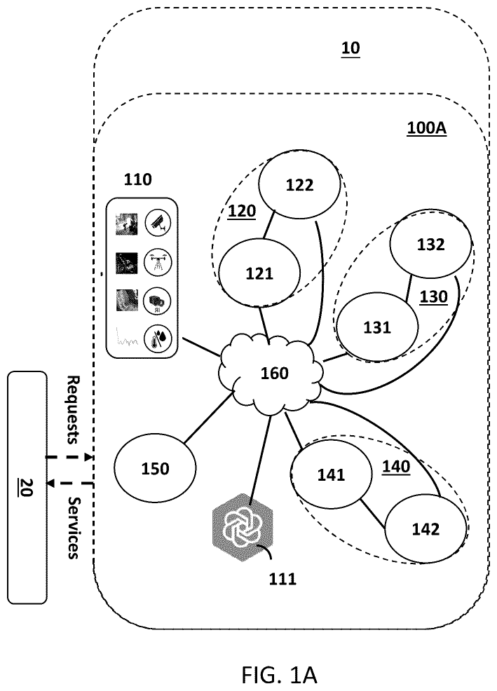

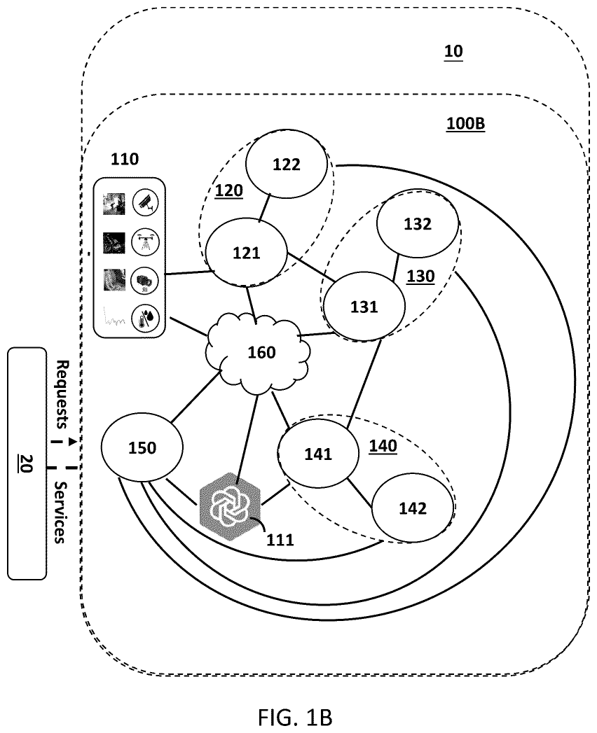

FIG. 1A shows a communication system 100A for facilitating an service delivery AI agent (also known as service providing AI agent) to respond to a request from a peer service requesting AI agent (also known as service receiving AI agent) in a scene in accordance with one embodiment of the present invention.

As shown, the communication system 100A is implemented in the AI sender or connected to the AI sender through a network. The communication system 100A comprises: one or more sensory devices 110 for collecting data from the scene in real-time; and a large language model module 111 for constructing a mission-specific event dictionary (containing a structured list of related event types) when the request is associated with a mission assigned to the peer AI agent.

The system 100A further comprises a perception engine 120 configured to process (including, but not limited to, data screening, feature extraction, preprocessing) the collected data; a cognition engine 130 configured to extract semantic information from the processed data (including, but not limited to, natural language parsing, semantic segmentation, entity recognition or other AI algorithms); and a decision engine 140 configured to detect one or more mission-relevant events from the extracted semantic information based on the mission-specific event dictionary.

The system 100A further comprises an operating platform 160 including one or more processors and a memory in communication with the one or more processors. The instructions are configured to cause, when executed by the one or more processors, cause the communication system to operate at: a perception tier such that the perception engine is further configured to encode the processed data; a cognition tier such that the cognition engine is further configured to select one or more scene descriptions from the extract semantic information; or a decision tier such that the decision engine is further configured to generate mission-relevant event descriptors based on the one or more detected mission-relevant events.

The system 100A further comprises a communication module 150 configured to transmit the encoded data to the AI recipient at the perception tier; transmit the one or more selected scene descriptions to the AI recipient at the cognition tier; or transmit the generated mission-relevant response to the AI recipient at the decision tier.

The choice of communication module depends on the AI agent application's requirements for range, power, bandwidth, and network topology. For examples, the communication module may be selected from, but not limited to, Wi-Fi modules for local networking or cloud-connected systems; Bluetooth and BLE modules for short-range, low-power communication, especially in wearables or mobile-connected systems; LoRa modules for remote or outdoor deployments; Zigbee and Thread modules for reliable, low-bandwidth communication; or cellular modules which provide wide-area connectivity for mobile or remote autonomous units.

The operating platform 160 may serve as a communication hub between the sensory devices 110, LLM module 111, the perception engine 120, cognition engine 130, decision engine 140 and the communication module 150.

Specifically, the operating platform 160 may be configured to receive the request from the collected data from the sensory devices 110 and transmit the collected data to the perception engine 120; receive the encoded data from the perception engine 120 and transmit the encoded data to the communication module 150 when the system 100A is operated at the perception tier. The operating platform 160 may further be configured to receive the request from the communication module and transmit the request to the cognition engine 130; receive the selected scene descriptions from the cognition engine 130 and transmit the selected scene descriptions to the communication module 150 when the system 100A is operated at the cognition tier. The operating platform 160 may further be configured to receive the request from the communication module and transmit the request to the LLM module; and receive the mission-specific event dictionary generated from the LLM module and transmit the mission-specific event dictionary to the decision engine 140; receive the generate mission-relevant event descriptors from the decision engine 140 and transmit the generate mission-relevant event descriptors to the communication module 150 when the system 100A is operated at the decision tier.

FIG. 1B shows a communication system 100B in accordance with another embodiment of the present invention. The system 100B is similar to the system 100A except for that the sensory devices 110, the perception engine 120, the cognition engine 130, the decision engine 140, the LLM module 111 and the communication module 150 may be interconnected to exchange data, commands and processed results directly with one another.

Specifically, the communication module 150 may be configured to transmit the request to the LLM module directly. The sensory devices may be configured to transmit the collected data to the perception engine 120 directly. The communication module 150 may be further configured to: receive the encoded data from the perception engine 120 and transmit the encoded data to the AI recipient when the system 100B is operated at the perception tier; receive the selected scene descriptions from the cognition engine 130 and transmit the selected scene descriptions to the AI recipient when the system 100B is operated at the cognition tier; or receive the generate mission-relevant event descriptors from the decision engine 140 and transmit the generate mission-relevant event descriptors to the AI recipient when the system 100B is operated at the decision tier.

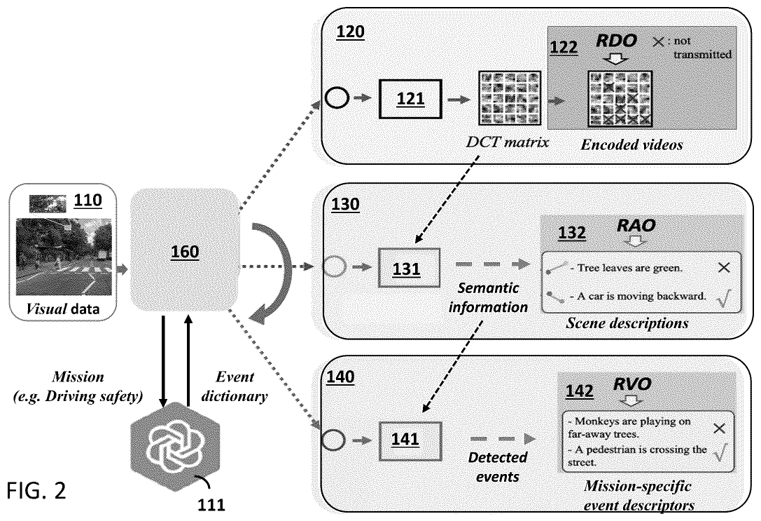

FIG. 2 illustrates an exemplary implementation of the communication system for a scenario in autonomous driving. If an autonomous vehicle (recipient vehicle) is stuck in a traffic jam (caused by a car accident) and wants to know and see what causes the jam, it can choose to communicate with another autonomous vehicle (sender vehicle) through the perception tier, in which non-text sensory signals such as videos are captured by the sender vehicle near the car accident, and transmitted to the recipient vehicle. The perception tier provides a movie-playing mode for perception by the recipient vehicle so that it can see the car accident by itself.

If the recipient vehicle wants to save time and bandwidth, it can choose to communicate with the sender vehicle through the cognition tier, in which text messages are generated to summarize the video captured by the sender vehicle; herein, the video is perceived by the sender vehicle rather than by the recipient vehicle. The cognition tier provides a story-telling mode for cognition by the recipient vehicle.

The recipient vehicle can also choose to communicate with the sender vehicle through the decision tier, in which the recipient vehicle lets the sender vehicle know its assigned mission (e.g., driving safely) such that only mission-relevant text messages are generated to summarize the video captured by the sender vehicle. The decision tier provides a gag-telling mode for the recipient vehicle's reaction, in which actionable text messages (like gags that are interesting to the recipient vehicle, making it laugh) can be automatically generated and transmitted to accomplish a specific mission. Taking the mission of driving safely as an example, the sender vehicle may transmit a message of “there is a car accident” to the recipient vehicle such that the recipient vehicle may detour to avoid being stuck in the jam.

In some embodiments, the perception engine 120 may comprise a data processing module 121 configured to process the collected data; and a data coding module 122 configured for encoding the processed data.

At the perception tier, the perception engine 120 is configured to facilitate efficient distributed perception with optimized resource utilization and perceptual clarity. In contrast to the conventional video coding modules that equate the visual quality with the coding bitrate (e.g., a higher bit rate indicates higher visual quality regardless of the video content), the coding module 122 relies on explainable and effective perceptual quality measures for encoder control. The quality measure, which is designed in a data-driven manner, not only delivers an accurate quality prediction from the perspective of human or AI perception, but also explains how global/local quality degradations lead to the predicted quality score.

For example, considering a scenario in autonomous driving where video footage from a vehicle's camera suffers from localized degradation due to adverse weather (e.g., raindrops partially obscuring the lens). Traditional encoders might indiscriminately demand higher bitrate encoding of the entire frame to improve perceived quality, resulting in unnecessary resource usage. In contrast, the coding module 122 is configured to identify and determine factors of the localized degradation, selectively allocate bitrate specifically to identified local degradation areas, thereby optimizing both resource utilization and perceptual clarity.

The coding module 122 is further configured to perform rate-distortion-power-delay optimization (RDO), optimizing the overall communication performance when transmitting the signals for perception. By considering the end-to-end delay and power consumption, the video coding for communication is optimized via multi-objective optimization, with the specific perceptual rate-distortion relationship incorporated.

The rate-distortion-power-delay optimization (RDO) algorithm is a multi-objective optimization algorithm designed to simultaneously balance four critical aspects: bitrate, visual distortion, power consumption, and end-to-end delay. This integrated approach ensures that video transmission meets not only visual quality standards but also practical constraints in terms of latency and energy efficiency, which are essential for real-time applications such as autonomous driving and security monitoring.

For instance, consider autonomous driving where a vehicle transmits real-time video streams to a central processing unit or nearby vehicles for cooperative perception. Traditional approaches might focus only on reducing bitrate to lower bandwidth usage, potentially increasing delay or processing power, which is unacceptable for real-time safety-critical tasks. Under the RDO algorithm, constraints are incorporated explicitly on end-to-end latency and power budget along with perceptual quality. Video encoding parameters are selected strategically to deliver optimal perceived video quality without exceeding latency constraints or depleting power excessively.

Another example would be a battery-powered drone used for remote surveillance. Here, power efficiency is crucial, and transmission delays must remain minimal to maintain real-time responsiveness. Under the RDO algorithm, dynamic adjustments are adopted in encoding strategies—such as selective frame dropping, adaptive compression levels, or regional encoding—to optimally trade-off visual quality against energy consumption and latency. By using a perceptual rate-distortion relationship, the system accurately assesses and prioritizes visual information that is most relevant from a human or AI perceptual viewpoint, further enhancing efficiency.

In some embodiments, the cognition engine 130 may comprise natural language processors 131 for extract and derive semantic information from the sensing outcomes; and a scene description selection module (or edge servers) 132 to perform cognition processing on the extracted semantic information.

At the cognition tier, the cognition engine 130 is configured to facilitate efficient distributed perception and cognition (DPC) through semantic communication techniques. Distributed perception is achieved with a plurality of sensors connected through a mobile network. Based on the assessment of feature importance and channel state, the scene description selection module 132 is configured to select and transmit only features and channels that satisfy the system requirements (i.e., accuracy, bandwidth, energy consumption and delay) through a selection criterion governed by a rate-accuracy optimization (RAO) algorithm for overall system performance. After the server coordinates the selective transmission from both the source and channel, the scene description selection module 132 would iteratively converge to global optimal performance under given bit-rate constraints (or budgets).

In some embodiments, the scene description selection module 132 may be configured, using the RAO algorithm, to select scene descriptions from the extracted semantic information based on their accuracy in reflecting common-sense under bit-rate budgets. As a result, messages that are interesting to the recipient from a common-sense perspective are transmitted to the recipient.

In some embodiments, the scene description selection module 132 may be configured, using the RAO algorithm, to strategically selects scene descriptions based on their semantic importance relative to a recipient's mission or task. Each candidate description is evaluated according to its relevance (accuracy in reflecting important, actionable, or mission-relevant information) and its required transmission resources (bit-rate). The goal is to maximize semantic value while minimizing bandwidth usage.

For instance, consider an autonomous driving scenario. The description “A car is moving backward” is highly relevant to the mission of driving safely because it directly impacts navigation decisions and poses immediate implications for safety. Thus, subject to the RAO algorithm, this description is assigned with high semantic importance, prioritized to be selected for transmission. In contrast, the description “Tree leaves are green” conveys information of negligible relevance to vehicle navigation or immediate safety decisions, despite possibly requiring similar transmission resources. Hence, subject to the RAO algorithm, this description is semantically irrelevant or of very low priority and thus is not selected. In essence, the RAO algorithm prioritizes descriptions with high mission relevance, such as actionable or safety-critical events, ensuring efficient bandwidth usage by excluding non-essential semantic information.

The decision engine 140 may comprise: an event detection module 141 configured for: detecting one or more mission-relevant events from the extracted semantic information based on the mission-specific event dictionary; an event analysis module 142 configured for: constructing a scene graph, wherein the scene graph including one or more triplets respectively representing the one or more detected events occurring in the scene; assigning a pragmatic value to each triplet in scene graph; selecting one or more triplets of highest pragmatic values; and converting the one or more selected triplets into the one or more mission-relevant event descriptors respectively.

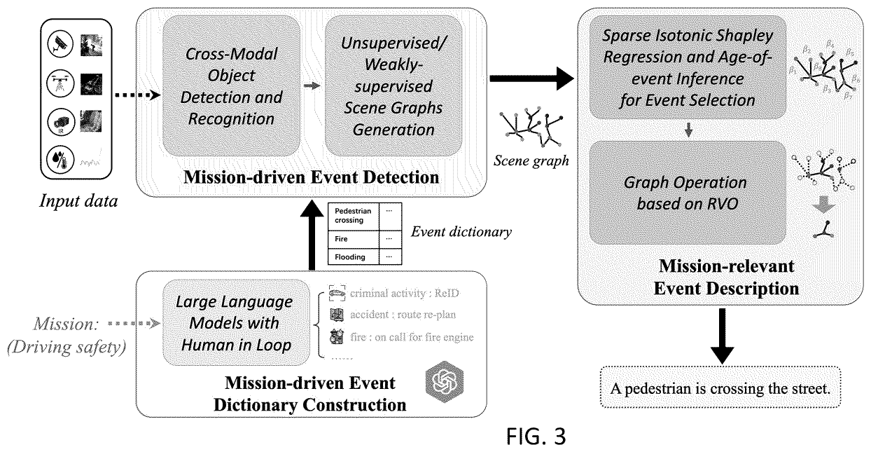

At the decision tier, mission-driven communication is achieved via mission-relevant event dictionary construction, event detection, and event description, as shown in FIG. 3. Specifically, the mission-relevant event dictionary serves as a structured repository (or list) containing events specifically relevant to a predefined mission, allowing for targeted event detection and description. Each mission has its own specialized dictionary, created by leveraging domain knowledge and large language models tailored to mission requirements.

For example, suppose the assigned mission is autonomous driving with an emphasis on traffic safety. A sample mission-relevant event dictionary in this context might include entries such as: “Traffic accident”, “Vehicle stopping suddenly”, “Pedestrian crossing road”, “Vehicle changing lanes abruptly”, “Traffic congestion”, “Road blockage”, “Emergency vehicle approaching”, “Objects falling onto road”, “Vehicle reversing on main road”. This dictionary explicitly excludes events irrelevant to driving safety-such as “birds flying” or “tree leaves rustling”-ensuring computational and communication resources are efficiently used only for critical events directly influencing the mission outcome.

It should be appreciated that the exemplary mission-relevant event dictionary is representative but not exhaustive. The complete dictionary would comprehensively list all mission-specific events relevant to decision-making processes in practice, such as limited bandwidth or computational power.

In some embodiments, the dictionary may be autonomously obtained with the guidance of intelligent agent based on large language models (LLM) (e.g., GPT), which ensures the accuracy and completeness of the event dictionary. For example, assuming the mission is detecting criminal activity, the autonomous vehicle can send a query to an LLM (which is tailored for public safety) and use the results from the LLM to create a dictionary, which consists of events of criminal activities.

Each entry in the event dictionary typically represents a distinct category or type of event (e.g., “traffic accident,” “pedestrian crossing”). During operation, multiple events from the dictionary may simultaneously be detected in a scene if they occur concurrently within the sensory data stream. Thus, multiple relevant events can indeed be detected in the scene simultaneously or sequentially, depending on the real-time scenario.

When an event from the mission-relevant event dictionary is selected, the event detection module 141 employs multi-modality sensory interpretation to detect and confirm the event occurrence within the captured sensory data. Specifically, the detection process involves fusing information from multiple sensor modalities collected by the sensory devices (e.g., cameras, LiDAR, radar, acoustic sensors), leveraging advanced deep learning models (such as Transformer fusion network, cross-modal alignment network, etc.) capable of cross-modal data integration. These models analyze and correlate different sensory inputs to robustly identify event signatures even under complex environmental conditions.

For instance, considering the event “vehicle stopping suddenly,” the event detection module 141 combines visual data (identifying abrupt speed changes through optical flow), LiDAR data (confirming sudden positional halts of detected objects), and acoustic signals (detecting rapid braking sounds), significantly enhancing detection accuracy compared to single-modality systems.

Once events are detected, the event analysis module 142 constructs a corresponding scene graph. The scene graph provides a structured representation of the detected event, explicitly capturing objects/entities and their semantic relationships. This involves identifying relevant objects, their attributes, and relational contexts derived from the detected event.

For example, for the event “pedestrian crossing road,” a scene graph might include nodes representing entities such as “pedestrian,” “road,” “crosswalk,” and relational edges representing interactions, e.g., “pedestrian is crossing road,” “pedestrian on crosswalk,” forming a clear semantic structure that directly describes the event scenario.

The scene graph thus offers an intuitive, structured representation of detected events, enabling effective downstream processing (e.g., pragmatic value assessment, decision-making) by explicitly encoding the spatial, semantic, and relational dynamics of events within a scene. Specifically, each triplet in the scene graph is assigned with a pragmatic value, reflecting its importance or relevance to the recipient's specific mission. The pragmatic value is computed through a trained deep-learning model (e.g., sparse isotonic Shapley regression model), which assesses each triplet's contribution to mission objectives based on historical data and contextual mission requirements.

The event analysis module 142 then identifies the final to-be-transmitted events based on the valuation on the scene graph through graph operations by means of a rate-value optimization (RVO) algorithm. The RVO algorithm employs a greedy or iterative strategy to condense the scene graph through selecting triplets with the highest cumulative pragmatic values under specified resource constraints (e.g., bit-rate or computational budget). For instance, if the bit-rate budget only allows the transmission of a limited number of triplets or bytes, the algorithm prioritizes triplets offering maximum pragmatic benefit per unit resource consumed. This process, known as scene graph condensation, strategically selects a subset of triplets (subject-predicate-object) from the full scene graph, ensuring the transmitted information is both concise and highly relevant to the recipient's mission.

For example, if the mission is autonomous driving safety, and the original scene graph contains multiple triplets like: (Car, stopped at, intersection), (Pedestrian, crossing, road), (Sky, is, cloudy). Under a tight resource budget, through the RVO algorithm, the first two triplets are selected due to their high pragmatic value related to immediate safety decisions, while the third triplet is omitted as it is of limited mission relevance despite consuming similar resources.

A “greatest value” may be computed as the sum of pragmatic values across the selected triplets within the condensed scene graph. This summation provides an objective measure to evaluate how effectively the condensed graph represents critical mission-relevant information. The goal is maximizing the total pragmatic value while adhering strictly to the specified resource constraints. Thus, the final condensed scene graph comprises only the triplets with highest cumulative pragmatic values, ensuring efficient use of resources and effective support of mission-critical decision-making.

Finally, the triplets in the condensed scene graph are converted into mission-relevant descriptors via a specific deep-learning-based transformer. By maintaining compactness in event descriptions, it can ensure that the detected objects and their contextual relationships are accurately represented and avoids making redundant representations.

The functional units and modules of the communication system in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

While the present disclosure has been described and illustrated with reference to specific embodiments thereof, these descriptions and illustrations are not limiting. The illustrations may not necessarily be drawn to scale. There may be distinctions between the illustrations in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. A system for facilitating communication between AI agents, comprising:
one or more sensory devices for collecting data from a scene associated to a request from a peer AI agent in real-time;
a large language model module for constructing a mission-specific event dictionary when the request is associated with a mission assigned to the peer AI agent;
a perception engine configured to process the collected data;
a cognition engine configured to extract semantic information from the processed data;
a decision engine configured to detect one or more mission-relevant events from the extracted semantic information based on the mission-specific event dictionary; and
an operating platform including a communication module, one or more processors and a memory in communication with the one or more processors and storing instructions that, when executed by the one or more processors, cause the system to operate:
at a perception tier such that the perception engine is further configured to encode the processed data and the communication module is configured to transmit the encoded data to the AI recipient agent;
at a cognition tier such that the cognition engine is further configured to select one or more scene descriptions from the extract semantic information and the communication module is configured to transmit the one or more selected scene descriptions to the AI recipient agent; or
at a decision tier such that the decision engine is further configured to generate mission-relevant event descriptors based on the one or more detected mission-relevant events and the communication module is configured to transmit the generated mission-relevant response to the AI recipient agent.

2. The system of claim 1, wherein the perception engine comprises:
a data processing module configured to process the collected data; and
a data coding module configured for encoding the processed data.

3. The system of claim 1, wherein the data coding module is further configured for encoding the processed data subject to a rate-distortion-power-delay optimization algorithm in which bite rate, visual distortion, power consumption and end-to-end delay are balance based on a specific perceptual rate-distortion relationship.

4. The system of claim 1, wherein the cognition engine comprises:
one or more natural language processors configured to extract semantic information from the processed data; and
a scene description selection module configured to select the one or more scene descriptions from the extracted semantic information.

5. The system of claim 4, wherein the scene description selection module is further configured to select the one or more scene descriptions from the extracted semantic information through a rate-accuracy optimization algorithm based on accuracy in reflecting common-sense under a bit-rate budget.

6. The system of claim 4, wherein the scene description selection module is further configured to select the one or more scene descriptions from the extracted semantic information through a rate-accuracy optimization algorithm based on accuracy in reflecting mission-relevant information under a bit-rate budget.

7. The system of claim 1, wherein the decision engine comprises:
an event detection module configured to: detect one or more mission-relevant events from the extracted semantic information based on the mission-specific event dictionary;
an event analysis module configured to:
construct a scene graph, wherein the scene graph including one or more triplets representing the one or more detected events occurring in the scene;
assign a pragmatic value to each triplet in scene graph; and
select one or more triplets of highest pragmatic values; and
a deep-learning-based transformer configured to convert the one or more selected triplets into the one or more mission-relevant event descriptors.

8. The system of claim 1, wherein the one or more triplets of highest pragmatic values are selected through a rate-value optimization algorithm under a specified bit-rate budget.

9. The system of claim 7, wherein the mission-relevant events are detected through multi-modality sensory interpretation.

10. The system of claim 7, wherein
the pragmatic value is computed through a trained deep-learning model; and
the trained deep-learning model is configured to access contribution of each triplet to mission objectives based on historical data and contextual mission requirements.
